(19) United States
(12) Patent Application Publication
(10) Pub. No.: US 2008/0270239 A1
(43) Pub. Date: Oct. 30, 2008

(54) METHOD FOR AN ENTERPRISE HEALTH CARE INCENTIVE PROGRAM

(76) Inventor: Christopher Najor, Grand Ledge, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/110,819

(22) Filed: Apr. 28, 2008

Related U.S. Application Data
(60) Provisional application No. 60/914,647, filed on Apr. 27, 2007.

(51) Int. Cl. G06Q 10/00; G06Q 50/00

(52) U.S. Cl. 705/14

(57) ABSTRACT

A method for an enterprise healthcare incentive program may include providing a training facility or health club having one or more exercise facilities and that may issue to a enterprise entity one or more memberships that permit use of the club's facilities. The enterprise entity may then distribute the memberships to one or more of its employees. The enterprise entity may also establish minimum standards for use of the membership by its agents. The club may then record use of the membership and club facilities by the agent over one or more predetermined time periods and then provide a report documenting such use to the enterprise entity. Where an agent has used the club facilities, and met or exceed the minimum standards set by the enterprise entity, the agent may be rewarded with a monetary or non-monetary benefit.

### CROSS-REFERENCE TO RELATED APPLICATIONS

This application is a Non-Provisional of Provisional (35 USC 119(e)) application 60/914,647. filed on Apr. 27, 2007, the disclosure of which is incorporated herein by reference.

### FIELD OF THE INVENTION

Disclosed herein is a method for a health and wellness program. More specifically, the disclosed herein is a fitness program that may involve a health club and an enterprise entity in which an agent of the enterprise entity is issued memberships by the health club and may be assigned certain minimum standards by the enterprise entity for use of that membership. Success by the agent in achieving the minimum standards may result in a benefit being awarded by the enterprise entity to the agent.

### BACKGROUND OF THE INVENTION

It is a commonly expressed notion that regular exercise will result in better health. It is also widely expressed that healthcare costs have increased at a rate that has outstripped the ability of many small and midsize corporations' to provide healthcare insurance for their employees. As a result, companies small and large are resorting to self-pay or medical reimbursement programs to mitigate costs or lower premiums.

In a self-pay or medical reimbursement program, a company takes it upon itself to directly pay some or all of an employee's healthcare costs. Furthermore, in many cases, the company will charge each employee a monthly fee that is deducted directly from the employee's pay to help offset the company's healthcare costs.

Accordingly, it would be beneficial to the employee and the company to have a health program that may reduce the company's overall healthcare costs and that also benefits the employee by providing him or her with an incentive to be more physically fit.

### SUMMARY OF THE INVENTION

The method disclosed herein benefits the enterprise entity by providing the means for its agents to work to become more physically fit. Physically fit employees may provide greater value to the enterprise entity, and the entity's healthcare plan, through lower incidents to sickness, increased strength and stamina, and other benefits that are typically associated with good health. The agent/employee may benefit not only from the clear health gains, but also from his or her receipt of a monetary or non-monetary incentive provided by the enterprise entity that may be awarded by the enterprise entity in return for the agent's meeting of certain fitness goals established by the enterprise entity. Finally, the training facility/heath club (that in some instances may be part of or associated with the enterprise entity) may benefit by the resulting increase in membership and/or use of its equipment.

A method for an enterprise health and wellness program may include a training facility or health club having one or more exercise facilities and which may issue one or more memberships, tracking numbers, PINs or the like to a enterprise entity that permit use of the club's facilities. The enterprise entity may then distribute the tracking numbers to one or more of its employees, workers and/or agents. The enterprise entity may also establish minimum standards for use of the membership and club facilities by its agents. The club may then record use of the tracking number in connection with exercise facilities for one or more predetermined time periods (e.g., a weekly, a monthly, bimonthly, quarterly, annually, etc.) and provide a report documenting such use to the enterprise entity.

If the agent does not use the club facilities during the predetermined period of time, the enterprise entity may take no action against the agent or may it may penalize the agent. Furthermore, if the agent has used the club facilities during the predetermined period of time, but did not meet the enterprise entity's minimum standards, the agent may likewise be penalized or no action may be taken. However, where an agent has used the club facilities, and met or exceed the minimum standards set by the enterprise entity, the agent may be rewarded with a monetary or non-monetary benefit, or the enterprise entity may take no action.

### BRIEF DESCRIPTION OF THE DRAWINGS

Reference will now be had to the drawing wherein like reference numerals refer to like parts throughout and wherein:

FIG. 1 is a flowchart view of an embodiment of a method for a health and wellness program in accordance with the present invention.

### DETAILED DESCRIPTION OF THE PREFERRED EMBODIMENTS

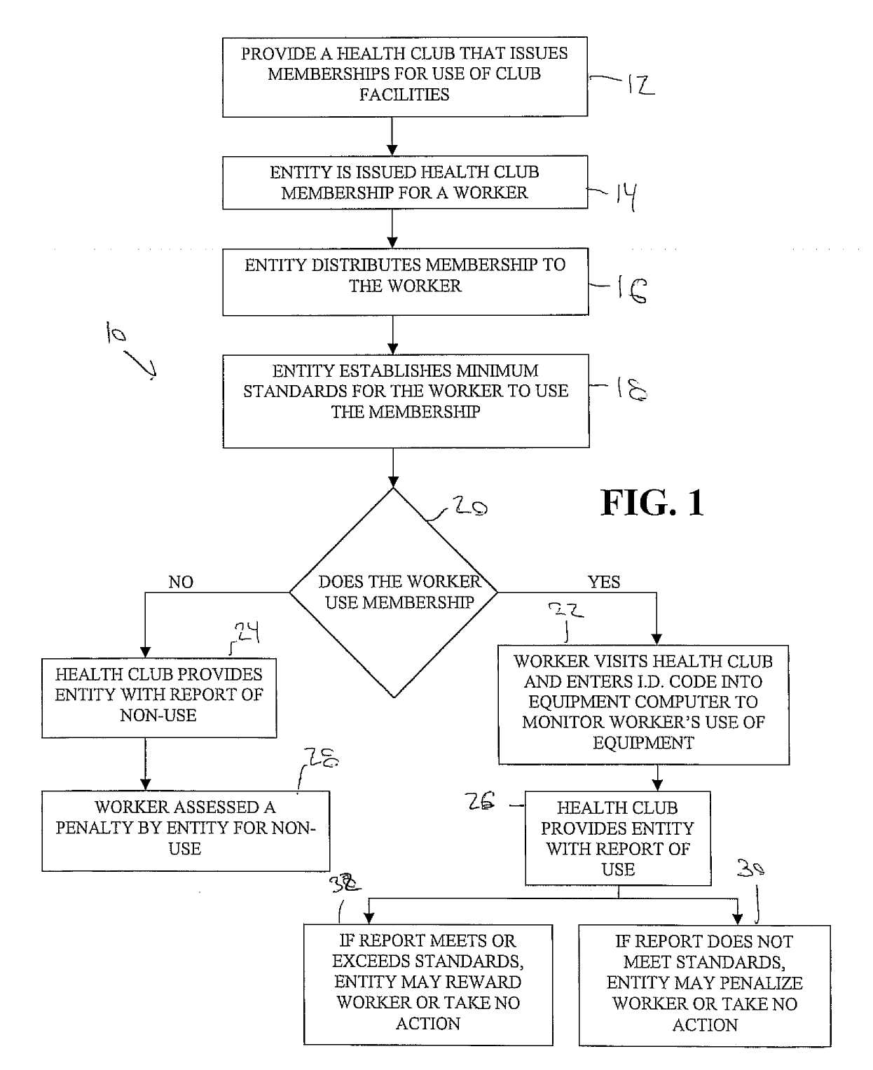

Referring now to FIG. 1, in one embodiment of a method for an enterprise health and wellness program 10 a training facility or health club having one or more exercise facilities may issue one or more memberships, tracking numbers, PINs or the like that permit use of the club's facilities to a enterprise entity. The enterprise entity may then distribute the tracking numbers to one or more of its employees, workers and/or agents. The enterprise entity may also establish minimum standards for use of the membership and club facilities by its agents. The club may then record use of the tracking number by the agent(s) in connection with exercise facilities during a predetermined time period and then provide a report documenting such use to the enterprise entity.

Where the agent has not used the club facilities during the predetermined period of time, the enterprise entity may take no action against the agent or may it may penalize the agent. Where the agent has used the club facilities during the predetermined period of time, but did not meet the enterprise entity's minimum standards, the agent may likewise be penalized or no action may be taken. However, where an agent has used the club facilities, and met or exceed the minimum standards set by the enterprise entity, the agent may be rewarded with a monetary or non-monetary benefit, or the enterprise entity may take no action.

The enterprise entity may include any manner of organization, association or group. For example, the enterprise entity may be a small or large unincorporated (include DBA's, associations, societies, partnerships, etc) or incorporated (including S corps, C corps, LLC's, etc). The enterprise entity may also be a non-profit, commercial, manufacturing or industrial organization. The enterprise entity may also include a collection or group of two or more such entities, which may or may not be of the same type. The enterprise entity may also include and/or incorporate the entity's insurance carrier.

The training facility or health club may be part of, or separate from, the enterprises entity. For example, the health club may include an on-site or off-site fitness facility of varying size such as a small in-office fitness room or a large fitness chain such as BALLYS or GOLDS GYM. By way of a still further example, the business entity may be a manufacturing operation having 500+ employees, while the training facility may include a privately owned and operated health club located near the manufacturing facility. In yet another example, the business entity may be the global headquarters building of a large multinational corporation, and the training facility may be located in the basement of the building.

Referring again to FIG. 1, in one step 12 of the disclosed embodiment may include providing a training facility or a health club that may generate or otherwise issue memberships, tracking numbers or the like that permit use of club facilities.

Still referring to FIG. 1, in another step 14, the enterprise entity may be issued, generate or otherwise be provided with membership(s) to the training facility.

Still referring to FIG. 1, in another step 16, these memberships then be distributed by the enterprise entity its agents.

Still referring to FIG. 1, in another step 18, the enterprise entity may establish minimum standards for use of the membership and club facilities by the agent. The enterprise entity may, for example, may mandate that each agent visit the health club and use the facilities a minimum number of days or hours each week, month or year. The minimum standards may also require that the agent: 1) use a certain type of equipment; or 2) follow the schedule of a personal trainer or dietician service. Accordingly, it will be appreciated that the minimum standards may require or contemplate the use of all of the facilities of the health club including, if available, spa services, pools and tubs, club dietician services, nutritionist services and personal trainer services. By way of further example, the minimum standards may also require that the agent visit with a club dietician at least once per year, a club nutritionist at least once per year, and a personal trainer at least three times a year. However, other standards not specifically identified above, but otherwise provided by a healthcare or training facility, may also be established by a particular enterprise entity.

Still referring to FIG. 1, in another step 20, an agent must decide whether to use the membership and club facilities. Then, in another step 22, the agent who visits the health club must enter his or her membership code/tracking number, etc. into whatever exercise facility is to be used, and then use that facility.

In this regard, it is notable that available health club equipment such as treadmills, ellipticals and stair climbers include onboard systems that allow recording of individual use. Specifically, facilities are available that allow an agent to enter an ID code into a particular facility (i.e., equipment or service), record the agent's use of that machine, and transmit the recorded data to a central processor or storage unit. One example of such a system is the VIVO system offered by the LEE FITNESS chain of health clubs. Another example is the commercially available FitLinxx system. In the commercially available FitLinxx system, for example uses a data collection system in which all exercise machines in a facility are networked into a central database. The system may then be directly interfaced by a user in the form of a touch-screen display interface that is attached to a machine. Specifically, to use a machine, each user enters his or her PIN into the system using the touch screen pad to log in and pull up the information on their personal exercise programs. The FitLinxx system then coaches the user on speed, form, heart rate, and so forth and tracks their workout sessions—each rep, set, and step. Information concerning the use of the machine is stored on central database that may be accessed from a workout-floor touch screen kiosk, at a staff computer station, or over an internet connection.

In addition, the commercially available systems identified above (and others) may be modified to include a digital camera integrated into the touch screen, kiosk or the like. The camera may be further programmed to photograph the agent each time he or she enters a tracking number to use a machine (or on a more random occasion). As a result, the agent's actual use of the machine may be subsequently verified.

Still referring to FIG. 1, the health club may issue a report to the enterprise entity, the entity's insurance carrier, or both, detailing an agent's use of the club facilities during a predetermined period of time. In those instances where an agent has not used the membership 24, a health club will simply provide the enterprise entity with a report of the non-use. Alternatively, where an agent has used the club facilities and properly entered the ID code into the club exercise facilities, the health club will provide the enterprise entity with a report of the agent's use of the club facilities 26.

Still referring to FIG. 1, in another step 28, an agent that is found to have not used the club facilities may be assessed a penalty by the enterprise entity or the enterprise entity may take no action. For example, where a report indicated that an agent has not used the club facilities, the enterprise entity may penalize the agent by increasing the amount of money deducted from the agent's pay to cover that agent's healthcare payments.

However, in another step 30, where a report on an agent indicated that the agent had used the club facilities, but had not met the minimum standards set by the enterprise entity, the enterprise entity may penalize the agent (as mentioned above, but to a less degree), or take no action.

Finally, in another step 32, where the report indicated that an agent had met or exceeded the minimum standards set by the enterprise entity, the enterprise entity may take no action or may reward the agent. For example, the enterprise entity may decrease the amount of money deducted from the agent's pay, provide the agent with a financial bonus, or provide the agent with a non-monetary benefit (such as a trip). However, other forms of incentives or disincentives or penalties may also be used to promote use of the club facilities.

Having thus described my invention, various other embodiments will become known to those who are skilled in the art that do not depart from the scope of the present invention.

I claim:

1. A method for an enterprise healthcare incentive program comprising the steps of:
receiving from a training facility a tracking number permitting use of an exercise facility at the training facility, the exercise facility having a data collection apparatus;
issuing the tracking number to an individual;
providing minimum standards for use of the tracking number by the individual in connection with the exercise facility at the training facility;
receiving from the train facility a report relating to the entry of the tracking number into the data collection apparatus of the exercise facility during a predetermined time period; and
issuing a benefit to the individual where the report indicates the individual has met the minimum standards.

2. The method of claim 1, wherein the data collection apparatus comprises a touchscreen and a database.

3. The method of claim 1, wherein the exercise facility is selected from a group consisting of an exercise machine and an exercise service.

4. A method for an enterprise healthcare incentive program comprising the steps of:
providing an enterprise entity;
receiving at the enterprise entity from a training facility a tracking number permitting use of an exercise facility at the training facility, the exercise facility having a data collection apparatus;
issuing the tracking number to an agent of the enterprise entity;
providing minimum standards for use of the tracking number by the agent in connection with the exercise facility at the training facility;
receiving at the enterprise entity from the train facility a report relating to the entry of the tracking number into the data collection apparatus of the exercise facility during a predetermined time period; and
issuing one of an incentive or disincentive from the enterprise entity to the agent based upon the agent's use of the tracking number as indicated by the report.

5. The method of claim 4, wherein the enterprise entity is selected from a group consisting of an unincorporated entity and an incorporated entity.

6. The method of claim 4, further comprising the steps of the enterprise entity compensating the agent for work performed by the agent for the enterprise entity, and the enterprise entity deducting from the compensation a predetermined amount for the agent's healthcare expenses.

7. The method of claims 6, wherein the incentive from the enterprise entity to the agent comprises a monetary benefit including a decrease in deduction of the agent's compensation.

8. The method of claims 6, wherein the disincentive from the enterprise entity to the agent comprises a monetary disincentive including an increase in the deduction of the agent's compensation.

9. The method of claim 4, wherein the incentive is selected from a group consisting of a monetary benefit and a non-monetary benefit.

10. The method of claim 4, wherein the data collection apparatus comprises a touchscreen and a database.

11. The method of claim 4, wherein the exercise facility is selected from a group consisting of an exercise machine and an exercise service.

12. The method of claim 4, wherein the exercise facility including a digital camera and further comprising the step of including with the report a photograph of the agent using the exercise facility.

13. A method for an enterprise health care incentive program comprising the steps of:
providing a training facility having an exercise facility, the exercise facility having a data collection apparatus;
issuing a tracking number from the training facility to an enterprise entity for use by agents of the entity in connection with the agent's personal health regime, the tracking number to be entered into the data collection apparatus by the agent to record use of the exercise facilities by the individual;
transmitting a report from the training facility to the enterprise entity relating to the entry of the tracking number into the data collection apparatus of the exercise facility during a predetermined time period.

14. The method of claim 13, wherein the data collection apparatus comprises a touchscreen and a database.

15. The method of claim 13, wherein the exercise facility is selected from a group consisting of an exercise machine and an exercise service.

16. The method of claim 13, further comprising the steps of providing a digital camera associated with the exercise facility; and photographing the agent upon entry of the tracking number into the data collection apparatus.
